(19) United States
(12) Patent Application Publication
(10) Pub. No.: US 2024/0217688 A1
(43) Pub. Date: Jul. 4, 2024

(54) Methods and apparatus for forming, filling and sealing film containers

(71) Applicants: Irvan Leo Pazdernik, Alexandria, MN (US); Corey Stephen Sundheim, Starbuck, MN (US); David L. Anderson, Alexandria, MN (US); Colin Michael Messer, Sauk Center, MN (US); Patrick Joseph Bierschenk, Dallas, TX (US); John Joseph Michels, Highland Village, TX (US)

(72) Inventors: Irvan Leo Pazdernik, Alexandria, MN (US); Corey Stephen Sundheim, Starbuck, MN (US); David L. Anderson, Alexandria, MN (US); Colin Michael Messer, Sauk Center, MN (US); Patrick Joseph Bierschenk, Dallas, TX (US); John Joseph Michels, Highland Village, TX (US)

(73) Assignee: Douglas Machine, Inc., Alexandria, MN (US)

(21) Appl. No.: 12/267,577

(22) Filed: Nov. 8, 2008

(51) Int. Cl. B65B 43/02; B31B 70/00; B31B 70/20; B65B 51/10

(52) U.S. Cl. CPC B65B 43/02; B31B 70/002; B31B 70/004; B31B 70/20; B65B 51/10

(57) ABSTRACT

A container (100) is formed by being folded and sealed on one of a multiplicity of male dies (12) of an apparatus (10). The male die (12) with the container (100) placed thereon is inserted into a female die (120). The female die (120) retains the container (100) while the male die (12) is removed therefrom. Lips (110-112) of the container (100) are sandwiched against the female die (120) while product is pushed thereon to prevent collapse of the container (100). The multiplicity of male dies (12) are relatively moveable by rotating about an axis (20) relative to the female die (120).

### BACKGROUND OF THE INVENTION

The present invention generally relates to packaging products, specifically relates to forming, filling and sealing containers and to containers created thereby, and particularly relates to forming, filling and sealing containers formed of plastic film and to containers created thereby.

Especially with the advent of warehouse type stores, multiple single serve sealed packages containing a food (which has a reduced shelf life after the package seal is broken) are sold as a unit to allow the consumer to buy the packaged food in bulk as opposed to one small package at a time. These packages and the foods contained therein, such as potato chips, tortilla chips, cookies, and other snack items, are referred to herein as “product” that is loaded into the container of the present invention. Thus, there is a need for containers which hold multiple products and which can be displayed on store shelves for display and purchase by the consumer. Film containers are preferred due to their lightweight, their ability to allow the multiple products to be viewed therein, the lack of bulkiness, and the like. Thus, there is a continuing need for improved film containers which maximize their advantages and minimize their deficiencies and even more so for improved methods and apparatus for forming, filing and sealing containers and especially film containers.

### SUMMARY OF THE INVENTION

The present invention solves this need and other problems in the field of packaging by providing improved methods and apparatus for forming, filling and sealing film containers. In a preferred aspect, the lips of a container received in a female die are sandwiched against the outer ends of the female die while product is pushed into the container and the female die to prevent collapse of the container into the female die.

In other preferred aspects, a male die with a container placed thereon is inserted into a female die, with the container being retained in the female die while the male die is removed therefrom and while receiving product placed therein after the male die is removed. The container and the product placed therein can be removed from the female die after closing the container.

In preferred forms, the container is placed on the male die by being formed thereon and in most preferred forms when folded and sealed upon the male die.

In preferred forms, the female and male dies are relatively moveable by rotation of the dies about axes and by movement of the axes relative to each other.

In preferred forms, a lid in the form of plastic film is sealed to the lips of the container after product is placed therein.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of an apparatus for forming, filling and sealing a film container according to the preferred teachings of the present invention.

FIG. 2 shows a plan view of a preferred form of a blank to be formed into a container utilizing the apparatus as shown in FIG. 1.

FIG. 3 shows a perspective view of a male die utilized in the apparatus as shown in FIG. 1.

FIGS. 4-11 show partial views illustrating the sequence of the methods for forming, filling and sealing a film container according to the preferred teachings of the present invention utilizing the apparatus shown in FIG. 1.

FIGS. 5A, 6A, 6B and 7A show perspective views illustrating the sequence of the methods for forming a blank into the container according to the preferred teachings of the present invention utilizing the apparatus shown in FIG. 1.

FIG. 12 is a perspective view of a heater strip utilized in the apparatus shown in FIG. 1.

FIG. 13 shows a perspective view of a sealed film container formed and sealed by the apparatus shown in FIG. 1.

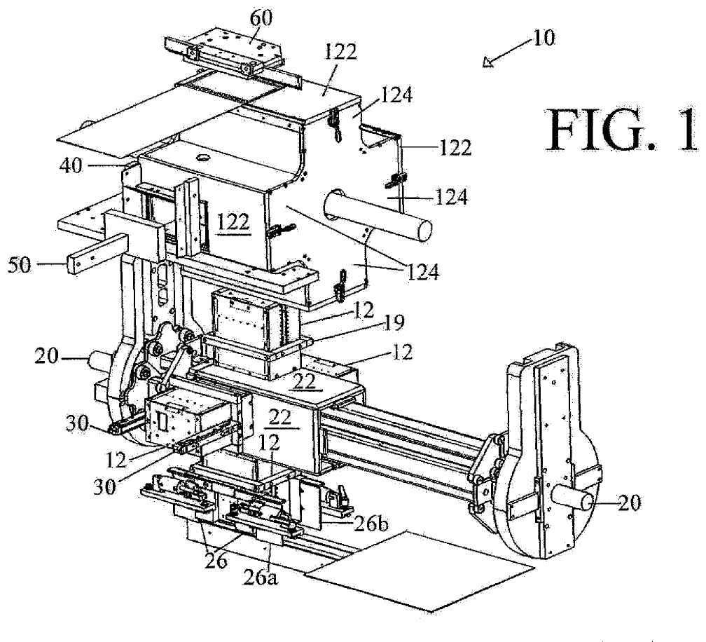

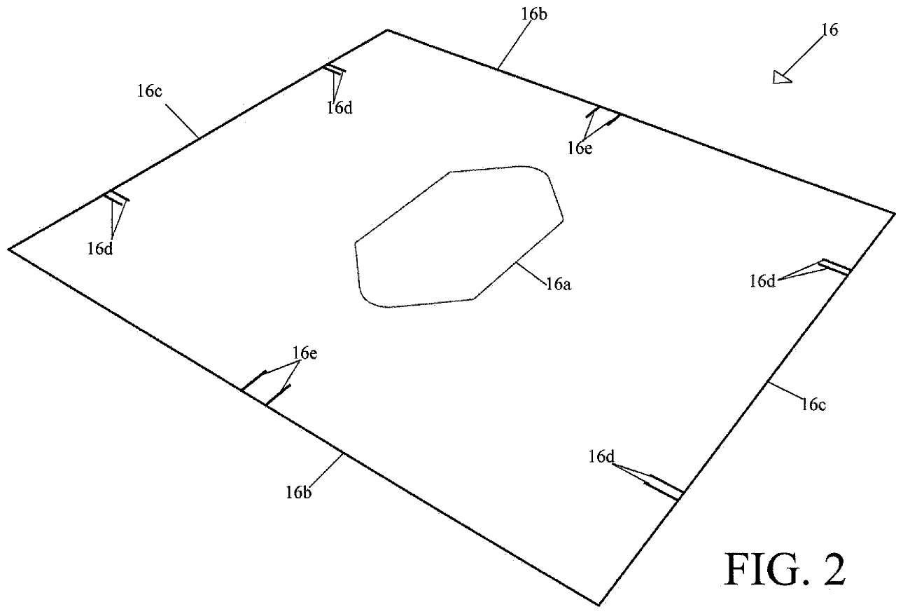

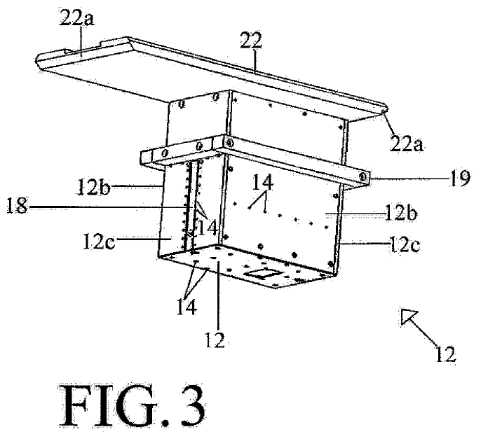

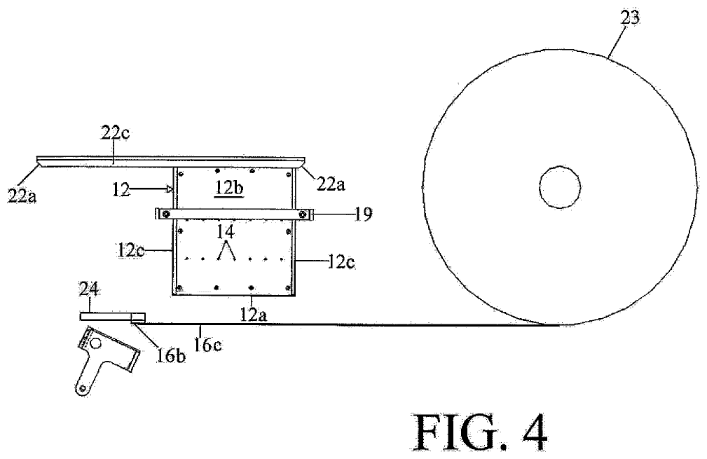

All figures are drawn for ease of explanation of the basic teachings of the present invention only; the extensions of the figures with respect to number, position, relationship, and dimensions of the parts to form the preferred embodiments will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in the figures of the drawings, the same numerals designate the same or similar parts. Furthermore, when the terms “top”, “bottom”, “first”, “second”, “height”, “width”, “length”, “end”, “side”, “trailing”, “leading”, “upstream”, “downstream”, “horizontal”, “vertical”, “axial”, “radial”, “longitudinal”, “lateral”, and similar terms are used herein, it should be understood that these terms have reference only to the structure shown in the drawings as it would appear to a person viewing the drawings and are utilized only to facilitate describing the illustrative embodiments.

### DESCRIPTION OF THE PREFERRED EMBODIMENTS

An apparatus for forming, filling and sealing a film container according to the preferred teachings of the present invention is shown in the drawings and generally designated 10, with the container created thereby being generally designated 100. Generally, apparatus 10 includes at least one male die 12, preferably a multiplicity of dies 12, and in the preferred form shown four male dies 12. Each male die 12 is in the shape of a right parallelepiped and includes a bottom 12a, first and second faces 12b, and first and second sides 12c extending perpendicularly between first and second faces 12b. Bottom 12a extends perpendicularly between faces 12b and sides 12c. Each of bottom 12a, faces 12b and sides 12c include a plurality of vacuum ports 14 for holding a film container blank 16 thereto.

In the most preferred form, each side 12c includes a central scaling groove 18 extending intermediate and parallel to faces 12b and perpendicular to bottom 12a. In the preferred form shown, male die 12 further includes a removably secured annular collar 19 located intermediate the upper ends of faces 12b and sides 12c and bottom 12a and parallel to and spaced from bottom 12a. It should be appreciated that the spacing of collar 19 from bottom 12a defines the depth of container 100.

In the most preferred form, male dies 12 are rotatably mounted about an axis 20 and is moveable vertically in a plane including axis 20 between an operative position and a transfer position. In the preferred form shown, dies 12 are removably mounted for ease of changeover. In particular, the upper ends of faces 12b and sides 12c opposite to bottom 12a are connected to a mounting plate 22. Mounting plate 22 is suitably removably mounted radially spaced from and as a tangent to axis 20. Specifically, in the most preferred form shown, inwardly beveled edges 22a are formed on the ends of mounting plate 22 parallel to and spaced from sides 12c. The assembly mounting dies 12 includes a suitable clamping mechanism having a dovetail shaped cavity corresponding to and for receiving edges 22a. Thus, by clamping and unclamping the mechanism, mounting plate 22 with die 12 thereon can be removed and replaced such as for maintenance, changeover, or other reasons.

Film container blank 16 is formed of a plastic film of a right parallelogram shape and in the preferred form includes an annular perforation 16a. Blank 16 includes first and second side edges 16b and first and second end edges 16c extending generally perpendicularly therebetween, with perforation 16a located equidistant between side edges 16b and equidistant between end edges 16c. First and second pairs of slits 16d are formed in and extend perpendicularly from each end edges 16c. The spacing between the pair of slits 16d is generally equal to the length of sides 12c of male die 12. A pair of slits 16e are formed in and extend perpendicularly from each side edge 16b generally intermediate end edges 16c.

In operation, the blank 16 is placed under male die 12 while in the operative position and in a start station extending vertically downward below axis 20. In the most preferred form, first end edge 16b of blank 16 which is cut and slit from a continuous source of film such as roll stock 23 is gripped by a suitable gripping mechanism 24 which moves in a direction parallel to faces 12b of die 12. It should be appreciated that roll stock 23 can be braked to prevent roll stock 23 from turning and to act as a drag to keep necessary tension on the continuous source of film. Further, a tamper can contact the film to hold it in place for cutting slits 16d and 16e and perforation 16a and also to cut blank 16 from the continuous source of film.

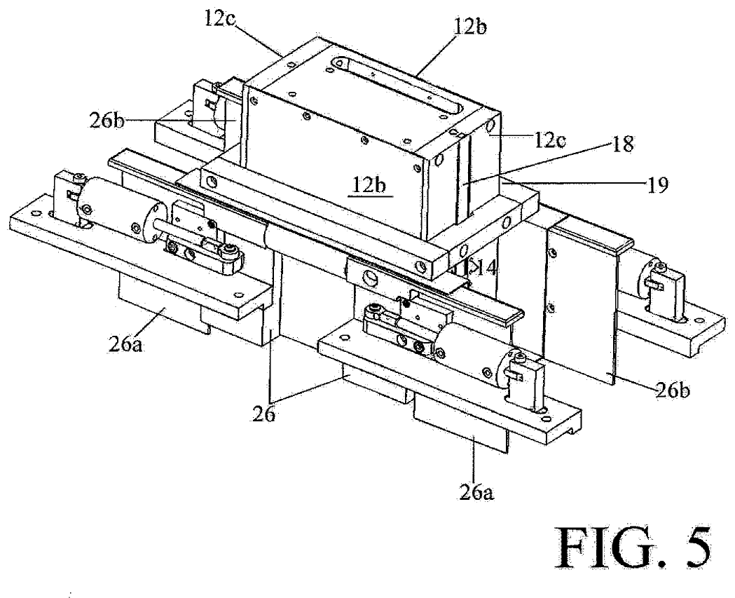

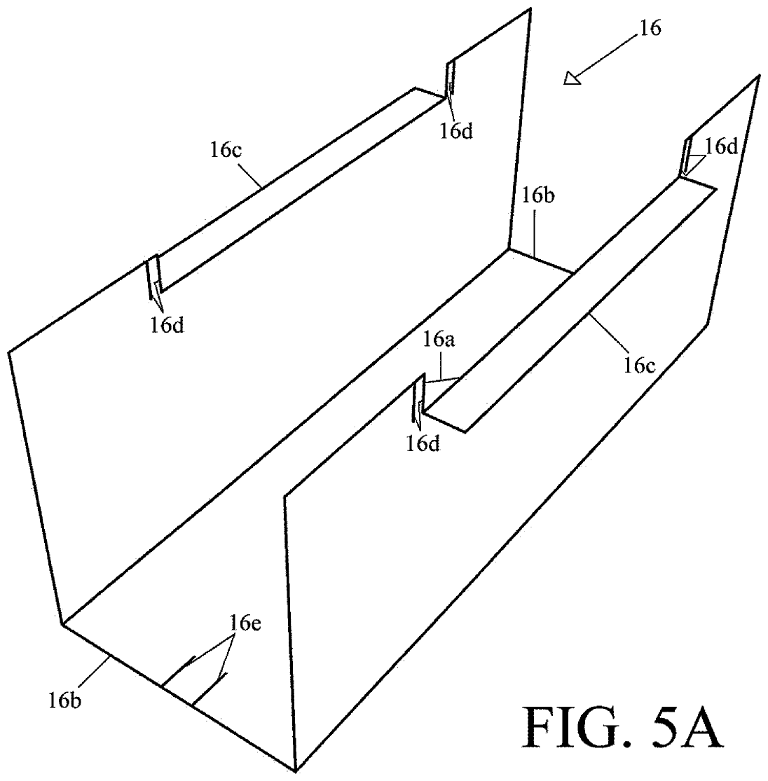

After blank 16 is placed relative to die 12, blank 16 and male die 12 are moved relative to each other such that bottom 12a engages blank 16. Further, blank 16 is folded to engage first and second faces 12b or in other words blank 16 is generally U-shaped. In the most preferred form, parallel forming bars 26 are raised to engage blank 16 and move it towards male die 12. Forming bars 26 are spaced generally equal to and for slideable receipt on faces 12b of die 12. Thus, with further movement of forming bars 26, blank 16 will engage bottom 12a and first and second faces 12b as best seen in FIG. 5A.

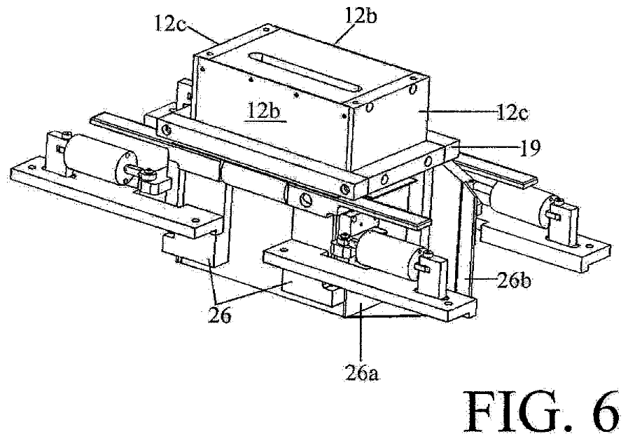

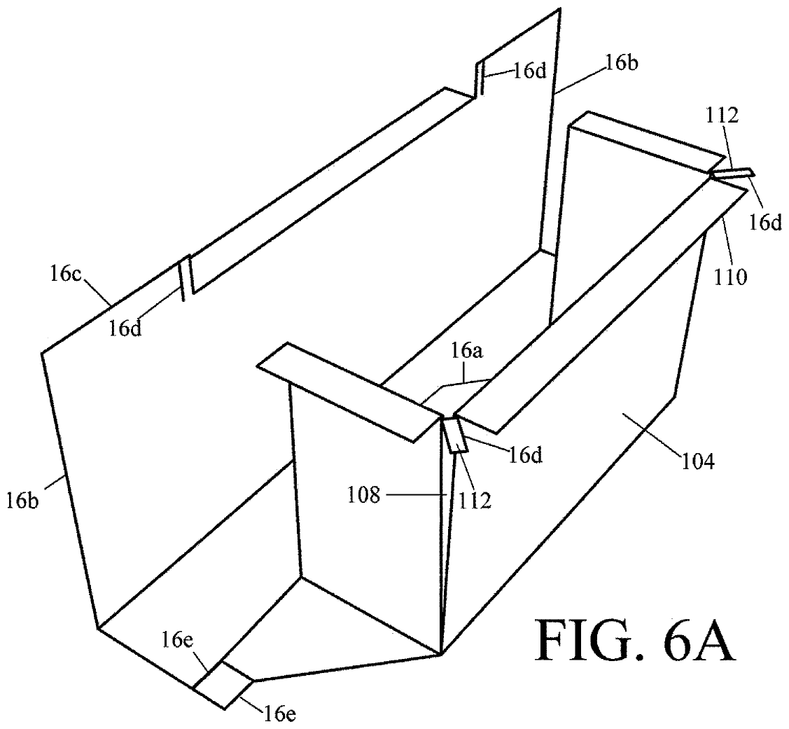

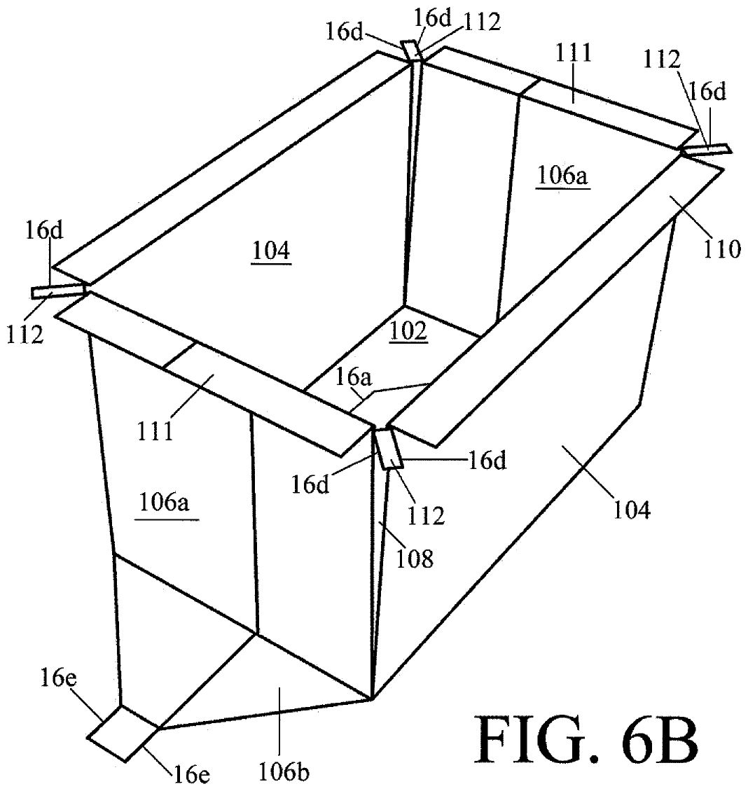

Thereafter, the portions of blank 16 extending beyond sides 12c are then folded to abut with sides 12c and overlap each other upon sides 12c. In the most preferred form, end portions 26a of one of the forming bars 26 pivots to abut the corresponding portions of blank 16 against side 12c as best seen in FIG. 5. After first end portions 26a return to their parallel position, second end portions 26b of the other of the forming bars 26 pivot as shown in FIG. 6 to abut the corresponding portions of blank 16 against side 12c and return to their parallel position as seen in FIG. 6A. Vacuum is applied to male die 12 in communication with vacuum ports 14 such that blank 16 abutting with male die 12 is held relative thereto during and after the folding process.

As best seen in FIG. 6B, container 100 at this stage includes a bottom panel 102 which is abutting with bottom 12a and is located equidistant between edges 16b and equidistant between edges 16e. Perforation 16a is located entirely in bottom panel 102. First and second face panels 104 abut with faces 12b and extend generally upwardly on opposite sides of bottom panel 102. Container 100 further includes first side panel portions 106a which abut with sides 12c and formed from the portions of blank 16 extending outwardly of slits 16d to side edges 16b which are folded on top of each other. It should be appreciated that when abutting with sides 12c, blank 16 further includes second panel portions 106b which extend beyond bottom 12a. In particular, panel portions 106b have first and second generally triangular portions having bases extending along the interconnection of sides 12c, with bottom 12a, with the first and second generally triangular portions separated by a right parallelepiped having a width equal to the spacing between slits 16e. Further, triangular panels 108 are defined between panels 104 and portions 106a and have a corner at the interconnection of panels 104 and portions 106 and bottom panel 102. The opposite corners of panels are defined by and between slits 16d.

It should be appreciated that collar 19 is positioned on die 12 such that blank 16 extends onto collar 19 when folded on die 12. In the most preferred form shown, forming bars 26 are positioned such that blank 16 includes a lip 110 abutting with collar 19 and extending generally perpendicular to faces 12b and panels 104. Similarly, end portions 26a and 26b are positioned such that blank 16 includes lips 111 abutting with collar 19 and extending perpendicular to sides 12c and panel portions 106a. Further, blank 16 includes lips 112 abutting with collar 19 and extending perpendicular to triangular panels 108. In the most preferred form, lips 110-112 are not continuous due to the presence of slits 16d in blank 16, with slits 16d and 16e having an equal extent as lips 110-112 in the preferred form shown.

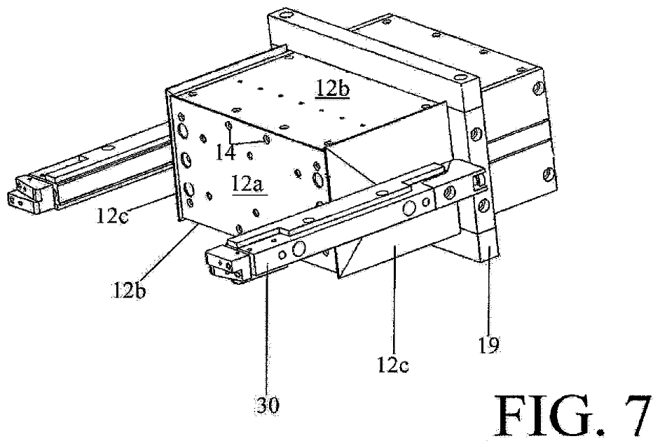

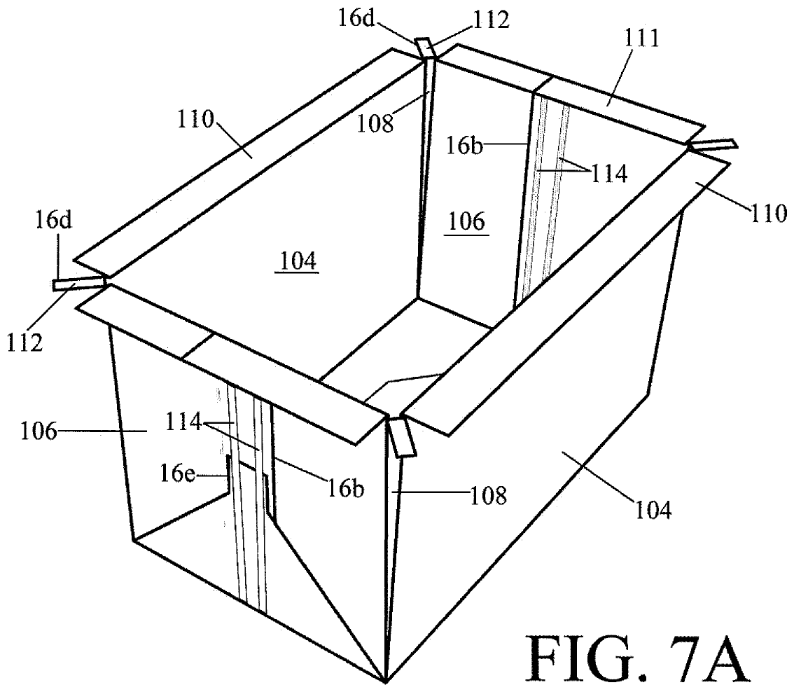

After blank 16 has been folded on die 12 and held thereon by vacuum, the folding mechanism folding blank 16 around die 12 such as but not limited to forming bars 26 is returned to its rest position. Thereafter, die 12 is rotated 90° in the preferred form to a scaling station including first and second sealing plates 30. In the preferred form shown, sealing plates 30 are shaped corresponding to but slightly larger than sealing grooves 18. Furthermore, projections are formed on sealing plates 30 corresponding to and for receipt into sealing grooves 18. In the sealing station, sealing plates 30 move from a rest position spaced from die 12 to a sealing position engaging portions 106b extending from bottom 12a and folds them to abut with portions 106a of blank 16 abutting with sides 12c as shown in FIG. 7. At that time, plates 30 are heated to seal blank 16 along seals 114 to form side panels 106 from portions 106a and 106b and to form an open top parallelepiped of a size and shape corresponding to die 12 as shown in FIG. 7A. In this regard, sealing grooves 18 and corresponding projections on plates 30 ensure that the sheet portions 106a and 106b are secured together. After sealing, sealing plates 30 move from the scaling position back to their rest position.

Generally, apparatus 10 includes at least one female die 120, preferably a multiplicity of female dies 120, and in the preferred form shown four female dies 120. Each female die 120 is in the shape of a right parallelepiped and includes a bottom 120a, first and second faces 120b, and first and second sides 120c extending perpendicularly between first and second faces 120b. Bottom 120a extends perpendicularly between faces 120b and sides 120c. Each of bottom 120a, faces 120b and sides 120c include a plurality of vacuum ports 140.

In the most preferred form, female dies 120 are rotatably mounted about an axis 180. In the preferred form shown, dies 120 are removably mounted for ease of changeover. In particular, the outer ends of faces 120b and sides 120c are connected to a mounting plate 122. Mounting plate 122 is suitably removably mounted radially spaced from and as a tangent to axis 180. The assembly mounting dies 120 includes a plurality of enclosures 124 having an opening corresponding to plates 122 and of a size and shape for receiving die 120. A suitable clamping mechanism clamps the mounting plates 122 to enclosures 124. Thus, by clamping and unclamping the mechanism, mounting plate 122 with die 120 thereon can be removed and replaced such as for maintenance, changeover, or other reasons. Apparatus 10 generally includes sources of vacuum and pressurized air in fluid communication with the interior of enclosures 124.

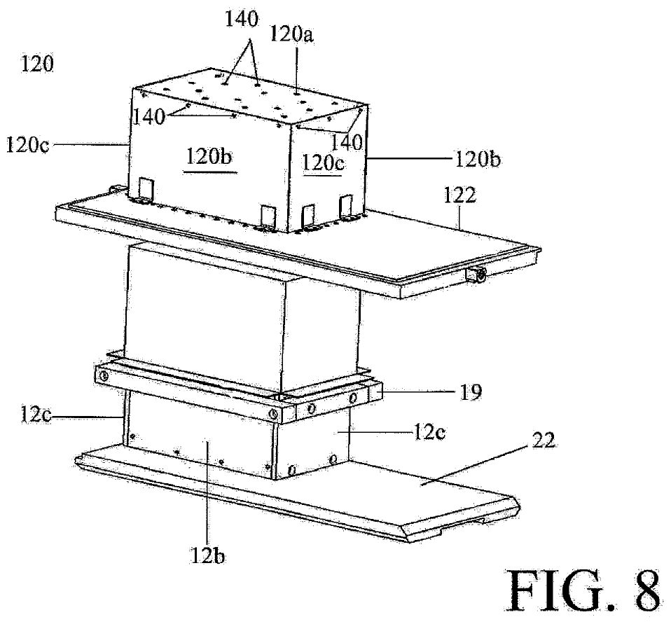

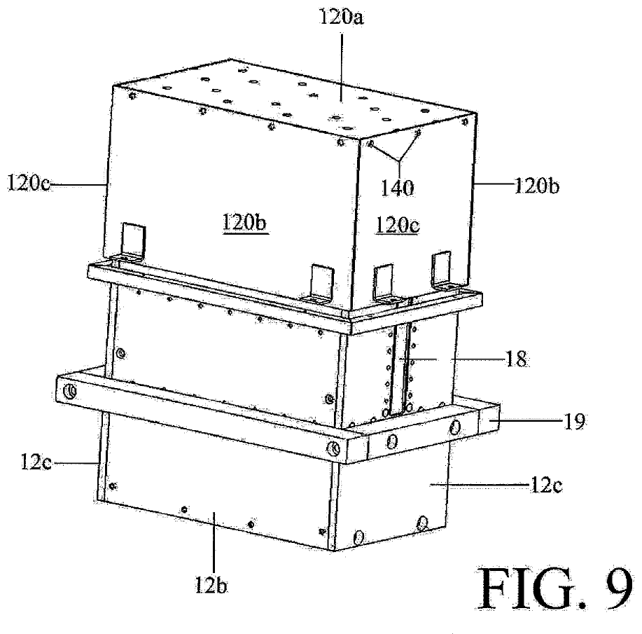

After sealing plates 30 have moved to their rest position and while sealed blank 16 is held upon die 12 by vacuum, die 12 is rotated 90° to an upper position. In the most preferred form, die 12 in its upper position is aligned with female die 120 in an inverted position as diagrammatically shown in FIG. 8. At that time, male die 12 is moved to its transfer position wherein sealed blank 16 and male die 12 move into and are received in female die 120 as diagrammatically shown in FIG. 9. When so received, vacuum to ports 14 is terminated and vacuum to enclosure 124 and to ports 140 is turned on. Thus, sealed blank 16 is then held by and abuts against bottom 120a, faces 120b, and sides 120c of female die 120. At that time, male die 12 can be moved from its transfer position to its operative position. As the sealed blank 16 is connected by vacuum within female die 120, sealed blank 16 will remain in female die 120 and slide off male die 12.

After male die 12 is moved to its operative position, male die 12 can be rotated 90° to an inactive station 180° from the sealing station as part of its cycle of operation. In the next cycle of operation, male die 12 can be rotated 90° from the inactive station to the start station.

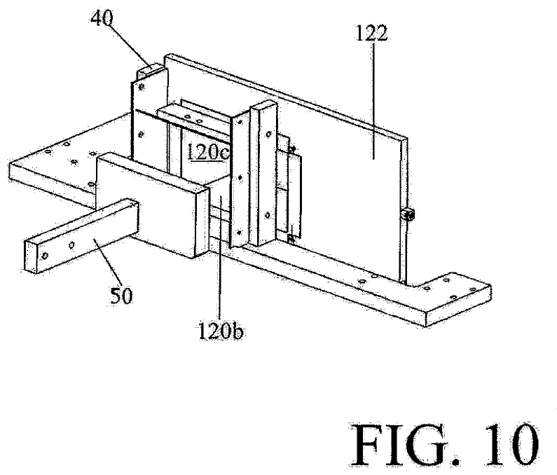

After male die 12 is in its operative position, female die 120 is rotated from its inverted position 90° to a horizontal loading position. It should be appreciated in the preferred form, sealed blank 16 is inserted into female die 120 by male die 12 such that the upper edges of sealed blank 16 having an extent generally equal to slits 16d and 16e and defining lips 110-112 are located outwardly of female die 120. With female die 120 in its loading position, a product contain mechanism 40 moves toward female die 120 and sandwiches lips 110-112 of sealed blank 16 against the outer ends of faces 120b and sides 120c of female die 120. Thereafter and as diagrammatically shown in FIG. 10, a load pusher 50 pushes product through product contain mechanism 40 and into the interior of female die 120. It should be appreciated that engagement of the product with sealed blank 16 docs not result in the collapse of sealed blank 16 due to the sandwiching of the upper edges thereof by product contain mechanism 40. After product has been pushed into female die 120, load pusher 50 and product contain mechanism 40 return to their rest positions.

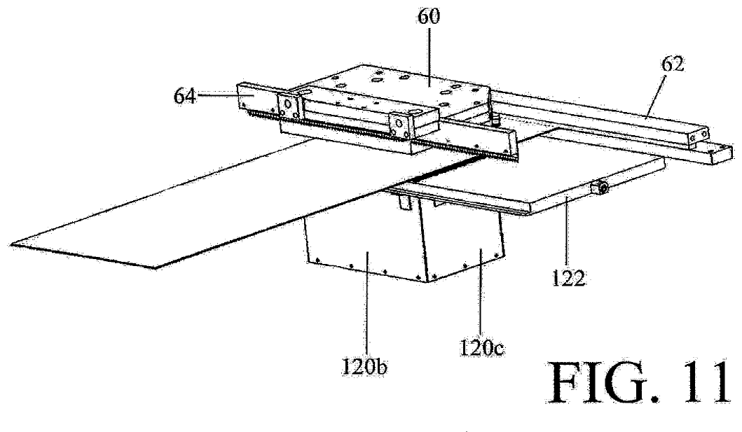

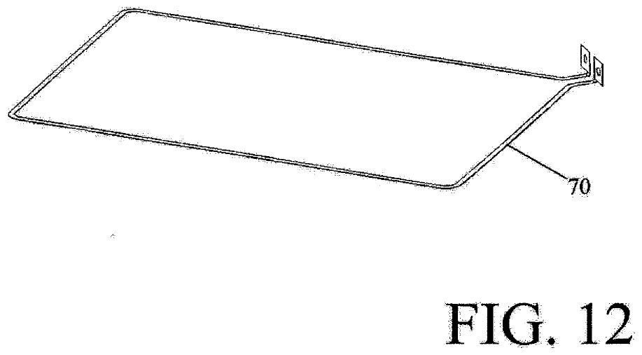

After product is loaded in female die 120, female die 120 rotates 90° to a vertical lid application position 180° from the inverted position. As diagrammatically shown in FIG. 11 and in the most preferred form, a continuous source of film such as roll stock gripped by a gripping mechanism 62 is moved to extend over the top of sealed container 16. An assembly 60 sandwiches the film against the top of the scaled container 16. A knife 64 carried by assembly 60 cuts a lid 160 from the film. Assembly 60 further includes a heater strip 70 shown in FIG. 12 moved to sandwich and seal lips 110-112 of sealed blank 16 and lid 160 against the outer edges of faces 120b of die 120. Thus, container 100 with product sealed therein is thereby created.

After sealing and after heater strips 70 and placer assembly 60 have been moved to their home positions, female die 120 is rotated 90° to a horizontal discharge position 180° from the horizontal loading position. Air pressure is applied to enclosure 124 and thereby ports 140 to force out the sealed film container 100 from the interior of female die 120. In the most preferred form, the discharged sealed film container 100 falls onto a discharge conveyor. After the sealed film container is discharged from female die 120, female die 120 can be rotated to its vertical inverted position for a new cycle of operation.

It should be appreciated that blank 16 and lid 160 can be formed of different materials according to the preferred teachings of the present invention. As an example, blank 16 could be formed of lower cost plastic material which does not readily accept printed material and which obtains its strength due to the seals created while forming the container and due to the sealing to lid 160. On the other hand, lid 160 can be formed of higher grade plastic material which readily accepts printed material. In this respect, it should be appreciated that lid 160 is not folded or overlapped during the formation of the sealed container.

Now that the basic teachings of the present invention have been explained, many extensions and variations will be obvious to one having ordinary skill in the art. As an example, although dies 12 and 120 are moveable about axes 20 and 180 shown and described in the preferred form as being parallel and horizontally disposed with axis 180 located vertically above axis 20, other arrangements and/or manners of movement of dies 12 and 120 can be contemplated according to the teachings of the present invention.

Similarly, various operations have been shown and described as occurring in various stations of dies 12 and 120 in the preferred form of the present invention. However, such operation could be performed in other manners and other locations according to the preferred teachings of the present invention. As an example, sealing of lid 160 to scaled container blank 16 could be accomplished by other manners and/or in more than a single station. Specifically, heater strip 70 could be divided and utilized in separate stations and believed to be advantageous at least for ease of minimizing changeover between differing container sizes,

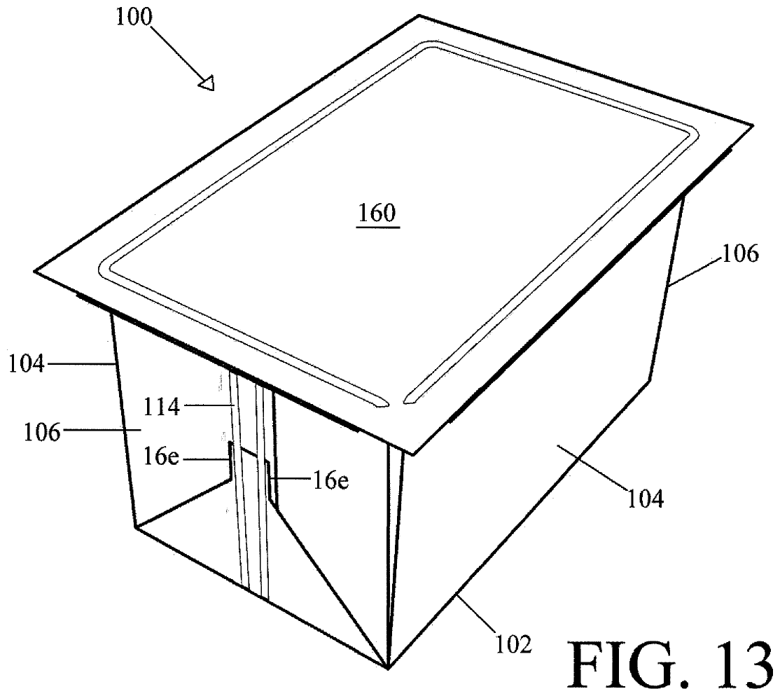

Referring to FIG. 13, it can be seen that what is formed by the present invention can be described as a container which is a formed bag consisting of a flexible film, said formed bag further comprising six walls consisting of a covered end wall 160 and four integral side walls 104, 106 integral with and perpendicular to one closed end wall 102, wherein said closed end wall 102 is opposite said covered end wall 160, and wherein further said side walls 104, 106 are slit at their respective intersections, thus forming four flaps at the covered end 160 of the formed bag. In a preferred embodiment, there is product contained within the walls of the formed bag and a cover 160 heat sealed onto said flaps, thus forming said covered end wall 160. Any one of the six walls 102, 104, 106, 160 may be perforated in order to allow access to the product contained therein. This product is typically a plurality of pillow bags, with each pillow bag containing a snack food.

Pillow bags are common in the prior art and are typically made by vertical form, fill and seal machines using a single web of film wrapped around a forming tube. The web of film then receives a back seal to form the web into a tube. An end seal is placed at the bottom of the tube, and a food product is then dropped through the tube into the pouch formed by the end seal. Another end seal is then formed above the level of the food, and the tube is cut at this upper end seal, thus forming the familiar pillow bag. These pillow bags are frequently used for containing snack foods such as potato chips, corn chips, pretzels, cookies, and other foods.

Such pillow bags have a higher rigidity at the end seals than along the rest of the body of the bag by virtue of the fact that the end seals are at least double (and in some locations, triple or quadruple) the thickness of the walls of the bag. Consequently, in a preferred embodiment of the present invention, when pillow bags are placed within the formed container, they are oriented such that the end seals of the pillow bags are parallel to the side walls of the container. Stated differently, when loaded in this preferred embodiment, the container holds a plurality of pillow bags all oriented with their end seals running perpendicular to the top and bottom of the container when displayed for sale. As a consequence, these end seals from the pillow bags provide additional rigidity and vertical support for the formed container.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Method comprising:
placing a container on a male die;
inserting the male die with the container placed thereon into a female die;
securing the container inside the female die and releasing securement by the male die;
removing the male die from the female die while the container is secured inside the female die;
placing product in the container secured inside the female die after the male die is removed from the female die;
closing the container after the product is placed in the container; and
removing the container with the product from the female die.

2. The method of claim 1 further comprising:
rotating the male die from a placing location to a transfer location about a male axis, with placing the container on the male die occurring while in the placing location and with inserting the male die occurring while in the transfer location.

3. The method of claim 2 further comprising:
rotating the female die from a receiving position to a loading position about a female axis, with inserting the male die occurring while the male die is in the transfer location and the female die is in the receiving position, with placing the product occurring while the female die is in the loading position.

4. The method of claim 3 with inserting the male die comprising relatively moving the male and female dies in a plane including the male and female axes in a spaced parallel relation and while the male die is in the transfer location and the female die is in the receiving position.

5. The method of claim 4 with placing the container comprising placing the container having an open top including a perimeter, with placing the product comprising inserting the product through the open top of the container, with closing the container comprising sealing a lid to the perimeter of the open top.

6. The method of claim 5 further comprising:
rotating the female die from the loading position after the product is placed in the container, with closing the container occurring after the female die is rotated from the loading position.

7. The method of claim 5 with placing the container comprising placing the container having a lip extending outwardly from the perimeter of the open top, with sealing the lid comprising providing the lid of a single thickness of a film and securing the film to the lip of the container.

8. The method of claim 7 with placing the product comprising sandwiching the lip against outer ends of the female die with a product contain mechanism, pushing the product through the product contain mechanism while sandwiching the lip and into the container and the female die, removing the product contain mechanism from the female die after the product is pushed, and with sealing the lid comprising sandwiching the lid and the lip against the outer ends of the female die with a heater strip.

9. The method of claim 2 with placing the container comprising placing a blank adjacent to the male die while in the placing location, folding the blank around the male die and securing the folded blank to create the container prior to the male die rotating to the transfer location.

10. The method of claim 9 with placing the blank comprising placing the blank adjacent to the male die of a right parallelepiped shape and including a bottom, first and second faces, and first and second sides, with folding the blank comprising engaging the blank with the bottom of the male die, folding the blank to engage the first and second faces with portions extending beyond the sides, folding the portions against the sides of the male die with overlaps, and securing the overlaps together.

11. The method of claim 10 with placing the blank comprising providing a continuous source of film, and cutting and slitting the continuous source of film to form the blank.

12. The method of claim 1 with securing the container comprising placing a vacuum to ports formed in the female die, with removing the container comprising removing the vacuum from the ports and applying air pressure to the ports to force the container out of the female die.

13. Apparatus for filling and closing a container comprising, in combination: a male die; a female die, with the male and female dies being movable relative to each other with the male die insertable into the female die; a container placement mechanism placing a container onto the male die while separated from the female die; a product loading mechanism placing product into the female die while separated from the male die and with the container received therein; and a container closing mechanism closing the container while the female die is separated from the male die.

14. The apparatus of claim 13 wherein the female die is rotatable about a female axis between a receiving position and a loading position, with the male die insertable into the female die while in the receiving position, with the product loading mechanism located adjacent to the female die in the loading position.

15. The apparatus of claim 14 wherein the male die is rotatable about a male axis between a placing location and a transfer location, with the container placement mechanism located adjacent the male die in the placing location, with the male die insertable into the female die while in the transfer position.

16. The apparatus of claim 15 with the male axis being parallel to and spaced from the female axis, with the male and female axes being relatively moveable in a plane including the male and female axes while the female die is in the receiving position and the male die is in the transfer location.

17. The apparatus of claim 13 with the female die including an opening defined by outer ends, with the product loading mechanism including a product contain mechanism abutting with the outer ends of the female die while separated from the male die, with the product loading mechanism including a pusher moving product through the product contain mechanism while abutting with the outer ends of the female die.

18. A container having six walls, said container comprising;
a formed bag consisting of a flexible film, said formed bag further comprising six walls consisting of a covered end wall and four integral side walls integral with and perpendicular to one closed end wall, wherein said closed end wall is opposite said covered end wall, wherein further said side walls are slit at their respective intersections, thus forming four flaps at the covered end of the formed bag;
a product contained within the walls of the formed bag; and
a cover heat sealed onto said flaps, thus forming said covered end wall.

19. The container of claim 18 further comprising perforation on at least one of the six walls.

20. The container of claim 18 wherein said product consists of a plurality of pillow bags.

21. The container of claim 20 wherein said plurality of pillow bags are oriented within said flexible film container such that the end seals on said pillow bags are parallel to the side walls of the flexible film container.
